(19) United States
(12) Patent Application Publication
(10) Pub. No.: US 2007/0239561 A1
(43) Pub. Date: Oct. 11, 2007

(54) System and method for selecting do-it -yourself projects and obtaining required materials thereof

(76) Inventor: James Tusing, Elm Grove, WI (US)

Correspondence Address: BOYLE FREDRICKSON S.C., 840 North Plankinton Avenue, MILWAUKEE, WI, 53203, US

(21) Appl. No.: 11/592,088

(22) Filed: Nov. 2, 2006

Related U.S. Application Data
(60) Provisional application No. 60/790,994, filed on Apr. 10, 2006.

(51) Int. Cl. G06Q 30/00

(52) U.S. Cl. 705/26; 705/400

(57) ABSTRACT

A system for enabling an individual to browse and select a particular project, such as a home improvement project or cooking recipe, from a list of available projects and to obtain all of the materials required for completion of the project is provided. The system includes a database including a number of projects of various types that can be selected by an individual in order to provide the individual with a list of materials required for each project. The system also provides the individual with price quotations for one or more of the materials required for completion of the project as submitted by various sources of these materials such that the individual can obtain all of the materials required for completion of the project in a particular manner desired by the individual.

### CROSS-REFERENCE TO RELATED APPLICATION

This application claims priority under 35 U.S.C. § 119 from U.S. provisional application 60/790,994, filed on Apr. 10, 2006, the entirety of which is expressly incorporated herein.

### FIELD OF THE INVENTION

The present invention relates to on-line shopping services and more specifically to a system that enables an individual to select a desired do-it-yourself project using various methods and to provide the individual with different options for obtaining all of the materials required to complete the selected project.

### BACKGROUND OF THE INVENTION

Many publications and other sources of information, e.g., the Internet, include as parts of the information contained therein various types of do-it-yourself projects which can be performed by an individual reading the publication. These projects include or cover many different types of subject matter, including recipes for preparing meals, plans for constructing various external household improvements, such as decks and play systems, and interior room remodeling projects, among others. In the information provided about these various projects in the information sources, normally a list of the different items or materials necessary for the completion of the project is included along with the steps required for the utilization of the materials in the list to complete the project.

If an individual desires to complete a project found in one or more of these publications or other information sources, the individual must first obtain or collect all of the necessary materials for completion of the project as listed in the project information. In many situations, the materials required for a specific project can be obtained from a single location, such as a large home improvement store or grocery store. However, on many other occasions, these materials are not readily available from a single source such that an individual wishing to pursue the project must make multiple trips to various locations to obtain all of the required materials for the selected project. In addition, even when all of the required materials for a desired project can be obtained from a single source, oftentimes either the source is not conveniently located with regard to the individual desiring to undertake the project, or it is not convenient to assemble all of the original materials at the source location.

However, with the advent of on-line shopping, it is now easier to obtain the various materials required from sources that are not conveniently located by purchasing the materials on-line and having the materials shipped to the individual. Nevertheless, because the individual undertaking the project often is not sufficiently well versed in the subject matter of the project to properly determine the correct materials for completion of the project, the individual can easily purchase materials on-line that are later realized to be inappropriate for the particular project when received by the individual.

Therefore, it is desirable to develop a system that enables an individual to select a particular project to be undertaken and to purchase items for the specific project in a manner which enables the individual to purchase all of the required materials for the project over the internet in a manner which assures that all the materials are obtainable by the individual in a relatively easy manner and that all the purchased materials are appropriate for use in completing the desired project.

### SUMMARY OF THE INVENTION

According to a first aspect of the present invention, a system is provided on which information regarding a number of different types of projects published in printed publications and other information sources is stored. An individual can browse through this information and/or identify the particular project of choice. Upon receiving the selection from the individual, the system provides the individual with comprehensive information concerning the project, including instructions for performing the project and a detailed list of materials required for completion of the project. If the individual wishes to obtain the materials required for completion of the project, the system can also receive a price quote from a number of sources for one or more of the materials required for completion of the project. The price quote received from each source can include a price including shipment of the material(s) to the individual, or a price for customer pick-up of the material(s), among other alternatives. In addition, when multiple or all of the required materials are obtainable from a single source, the price quote can include a quote for the pick up or shipment of a combined package including all of the required materials for completion of the project. These price quotes are then forwarded by the system back to the individual who can then select the desired source for the materials and the desired manner in which the materials are to be obtained by the individual utilizing various factors, such as the location of the source of the materials relative to the location of the individual and/or the price of the materials from a particular source relative to other sources for the same materials. Once the source for the materials has been selected by the individual, the system enables the individual to submit payment for the materials through the system to the selected source for the project materials.

According to another aspect of the present invention, the system allows the contractors and/or publishers of the various projects to submit the list of required materials for the specific projects and other project information (i.e., instructions) to the system for inclusion in a database of available projects that can be accessed by the individual through the system. Each project is assigned an identification code or number that is correspondingly associated with the project information including the list of materials and instructions stored in the system. The identification code can also be included in the various publications of the project information in the magazines and other information sources. Thus, an individual looking for a specific project utilizing the system can simply enter the identification code published with the project to quickly and easily access the materials list and other information for the selected project on the system.

According to still another aspect of the present invention, the system can be utilized to enable an individual to browse through projects of various types stored in the system, such as construction projects, home improvement projects, gardening projects, cooking projects and the like, and can submit the requests for materials required by these projects to sources of the various types of goods found in the material lists, such as home improvement stores and grocery stores, among others.

Numerous other aspects, features, and advantages of the present invention will be made apparent from the following detailed description taken together with the drawing figures.

### BRIEF DESCRIPTION OF THE DRAWINGS

The drawings illustrate the best mode currently contemplated as practicing the present invention.

In the drawings:

FIG. 1 is a schematic view of a system constructed according to the present invention; and

FIG. 2 is a schematic view of the operation of the system of FIG. 1; and

FIG. 3 is a schematic view of the price quotation function of the system of FIG. 1.

### DETAILED DESCRIPTION OF THE INVENTION

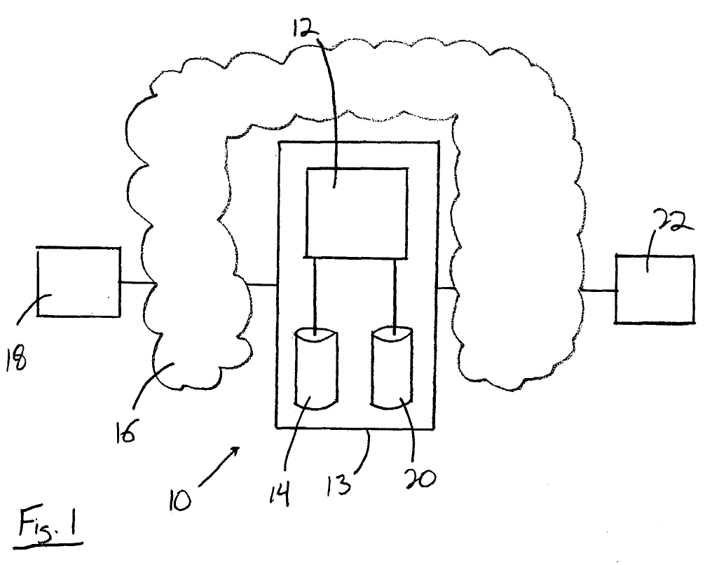

With reference now to the drawing figures in which like reference numerals designate like parts throughout the disclosure, a system constructed according to the invention is represented generally at 10 in FIG. 1. The system 10 includes a central processing unit 12 operatively connected to a first database 14 in which the information concerning a number of different types of do-it-yourself projects is stored. In a preferred embodiment, the central processing unit 12 is part of a larger computing device or server 13 that also contains the database 14.

The types of projects having information on them stored in the database 14 include, among others, cooking projects, arts and crafts projects, interior and exterior home remodeling improvement projects, gardening projects and other do-it-yourself projects. The information stored in the database 14 regarding each of these projects includes, but is not limited to, a detailed list of written, and optionally visual or graphical, instructions on how to begin and complete the particular project, and a comprehensive list of the materials required to complete the project. In addition, the database 14 contains unique identification codes or numbers associated with each of the projects stored on the database 14. These codes can be used on the system 10 to select or identify a particular project or projects of interest to a user, and can also be associated with any publications of the information on each project, such as in print or electronic version of a periodical or magazine generally related to the subject matter of the particular project.

The processing unit 12 or computing device 13 containing the unit 12 is operatively connected to a global computer network 16 in any suitable manner as is known in the art such that the unit 12, and consequently the database 14, can be accessed via the network 16 from a remote computing device or terminal 18, such as a home computer or mobile PC, among other suitable devices, in a manner to be described.

Additionally, the processing unit 12 is also operably connected to a second database 20. The database 20 contains stored information pertaining to a number of sources for the various goods or materials found on the material lists associated with each of the projects stored in the database 14 and required for completion of these projects. More particularly, the database 20 includes information concerning the locations of the various sources, and the different materials available from each source that are found in any one of the lists of required materials stored in database 14 in association with a particular project.

The processing unit 12 is also operably connected via the global computer network 16 to remote computing devices 22 located at the various material sources that have their relevant information contained in the database 20, such that the unit 12 can communicate with the remote devices 22 at the different sources via the network 16 in a manner to be described. In this manner, the processing unit 12 can facilitate communications between a user computer 18 and a source computer 22 when an individual is utilizing the system 10.

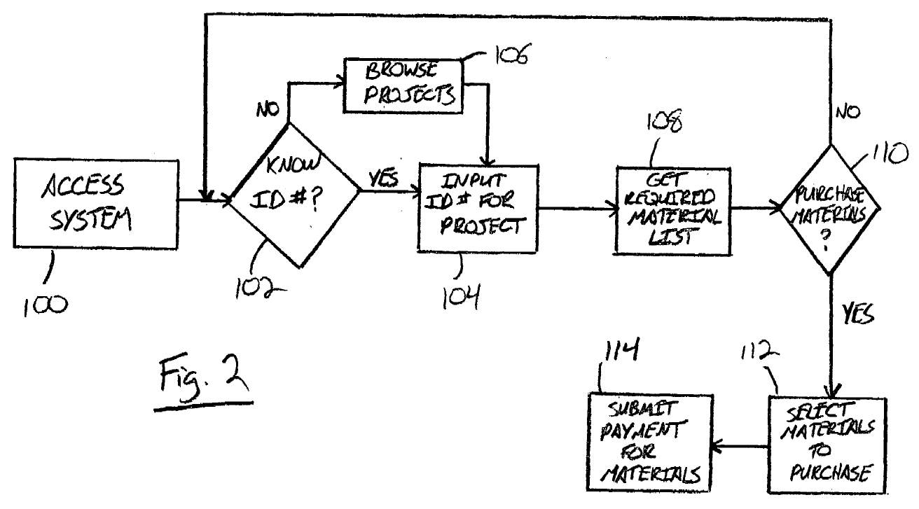

Referring now to FIG. 2, the overall method of operation or utilization of the system 10 is schematically illustrated. Initially, in block 100, the individual can access the system 10 utilizing the network 16, such as by typing a particular website address at which the system 10 is connected to the network 16 into any suitable Internet search engine or browser, e.g., Internet Explorer®. Alternatively, the user could access the system 10 via a computing terminal located at a particular retail or other suitable store that sells materials that are required by one or more of the projects stored in the database 14. Once connected to the system 10, in block 102 the individual is queried by the system 10 as to whether the individual knows the unique identification code for the particular project of interest. If yes, the system 10 moves to block 104 and allows the individual to input the specific identification code for the desired project as obtained from a print or electronic publication of all or part of the information concerning the desired project.

However, if the individual does not know the identification code for the particular project, or if the individual does not have a particular project in mind, and simply wishes to see what types of projects are available in the system 10, the system 10 proceeds to block 106 and provides the individual with access to the contents of the database 14, preferably in a read-only manner. In doing so, the system 10 can enable the individual to browse through the various categories of projects stored in the database 14, as well as the individual projects located in each category. Additionally, the system 10 can provide the individual with a suitable search engine to allow the individual to input certain search terms that are representative of the projects the individual is interested in. The search terms are then utilized by the system 10 to locate any information on any projects located within the database 14 that include these search terms, and to retrieve those projects for the individual in a known manner.

Once the individual has located a particular project of interest, the system 10 moves from block 106 to block 104 to enable the individual to input the identification code for the project, or alternatively to simply select the project by activating a link associated with that project. Once the project is selected using either method, the system proceeds to block 108 and provides the individual with all of the information stored in database 14 concerning the selected project, including a detailed list of materials required for completion of the project. This list of materials includes all of those materials that are essential for completion of the project, as well as various alternatives for the required materials, and any optional materials that can be used to enhance the finished results of the project. The list of materials required for the completion of the project provided to the individual is preferably supplied in a format where each material or the list may be selected to obtain additional information on that particular material. Additionally, each material on the list is preferably associated, both visually on the list itself, and through the unit 12 to the database 20, with one or more potential sources of the material.

If the individual reviews the material list and instructions for the project and decides not to pursue that particular project, in block 110, when the system 10 queries the user if they would like to purchase materials for the project, by selecting no, the user is directed back to block 100. However, if, after viewing the list of materials provided by the system 10 in block 108, the individual wishes to undertake the specific project, to indicate that one or more of the materials found on the list associated with the project are to be purchased, the system 10 proceeds in block 112 to allow the individual to select each of the materials from the list to be purchased. Upon completion of the selection of the materials to be purchased, in block 14 the system 10 solicits payment information from the individual, which is subsequently entered by the individual, and forwarded to the material source for verification and payment.

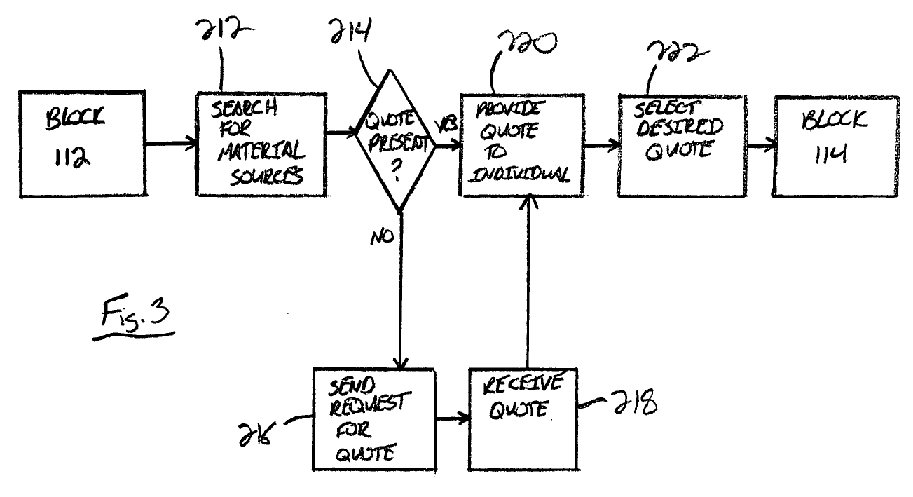

In obtaining the materials required for completion of the project, the system 10 can also provide different options for getting the materials to the individual utilizing the process that occurs in block 112. More particularly, referring now to FIG. 3, a more detailed version of the process step in block 112 is illustrated. In this process, when the individual initially selects the material(s) they wish to obtain from the list in block 112, the system 10 searches the database 20 for those material sources listed in the database 20 that can supply the selected material(s) in block 212. Once the sources for the material(s) are located, the system 10 determines in block 214 if there is a price quote for the material(s) already present in the database 20 for each located material source. If not, the system 10 subsequently solicits price quotations for the material(s) from each material sources that did not have a price quote for the material(s) in the database 20 in block 216. In block 216, the queries sent by the system 10 to each of the located sources are for price quotes concerning the specific material(s) requested and/or each of the materials on the particular project material list. The query is also structured to request from the sources of the material(s) the prices for various packaging and delivery options for the material(s). These options include a price for the single material or a price for a bundled package of multiple materials from the selected project materials list. Additionally, the requested prices can be for the delivery of the material or materials on the list directly to the individual or for the pick up of the materials or material from the source at a location close to the location of the individual. Then, in block 218, each material source submits the requested price quote to the system 10, that are subsequently provided to the individual in block 220.

Alternatively, price quotations for the selected material(s) may already be stored in the database 20 in association with each of the materials specified as being obtainable from each material source. Thus, with regard to each material source having a price quote in the database 20, the system 10 proceeds directly from block 216 to block 220 and presents the price quotes to the individual.

As discussed previously, the price quotes presented by the system 10 to the individual in block 220 can include different prices for the material(s) selected by the individual depending upon various pricing criteria, such as the number of items to be purchased, or a price including shipment of the material(s) to the individual, or a price for customer pick-up of the material(s). In addition, when multiple or all of the required materials are obtainable from a single source, the price quote presented in block 220 can include a quote for the pick up or shipment of an assembled or combined package including all of the required materials to be obtained from the source.

Upon reviewing the price quotes, the individual in block 222 can then select the particular source for the material(s) and the desired manner in which the material(s) are to be obtained by the individual utilizing various factors, such as the location of the source of the materials relative to the location of the individual and/or the price of the materials from a particular source relative to other sources for the materials. Once the source for the materials has been selected by the individual, the system 10 moves out of the selection process in block 112 to block 114, as described previously, and enables the individual to submit payment for the material(s) through the system 10 to the selected material source.

Further, the types and numbers of projects available in the first database 14 can be continually updated by placing new projects and the associated information including the identification code, instructions and required materials list in the database 14. Thus, when the new projects are published in later issues of a particular magazine or other publication, an individual can access the system 10 to view the information associated with that new project. Also, the price quotations stored in the database 20 can also be continually updated by the material sources by changing the price quotations for particular items, or by adding or removing certain items from the materials that can be provided by the particular material source.

Various alternatives are contemplated as being within the scope of the following claims particularly pointing out and distinctly claiming the subject matter regarded as the invention.

What is claimed is:

1. A system for procuring materials required for the completion of a particular project, the system comprising
a) a first database containing information regarding material lists for a number of projects including a list of materials required for the completion of the project;
b) a second database containing information on a number of sources of one or more of the materials found on the required material lists contained in the first database; and
c) a central processing unit connected to the first database, to the second database and to a global computer network, wherein the central processing unit is configured to receive a request for information concerning a project including the list of required materials from the first database, to provide price quotations for one or more of the materials from the list of required material from the sources contained in the second database, and to enable the purchase of the one or more materials from the list of required materials from one or more of the material sources stored in the second database.

2. The system of claim 1 wherein the central processing unit is configured to receive additional or updated lists of required materials for storage in the first database in association with particular projects.

3. The system of claim 1 wherein the central processing unit is configured to send requests for price quotations to material sources contained in the second database for materials on the list of required materials for the selected project.

4. A method for procuring materials required for completion of a particular project, the method comprising the steps of:
a) providing a system including a first database containing information regarding a number of projects including a list of materials required for completion of the project, a second database containing information on a number of sources of materials found on the lists of required material associated with the projects contained in the first database, and a central processing unit operably connected to the first and second databases and to a global computer network to enable the processing unit to be accessed via a number of remote terminals;
b) selecting a project from the first database;
c) obtaining at least one price quotation for at least one of the materials n the list of required materials to complete the selected project from at least one of the material sources stored in the second database; and
d) submitting payment for the materials to the at least one material source through the system.

5. The method of claim 4 wherein the step of obtaining the at least one price quotation comprises obtaining multiple price quotations from a single material source stored in the second database.

6. The method of claim 5 wherein the step of obtaining multiple price quotations from the single material source comprises:
a) obtaining a price quotation for pick up of the materials from the single material source;
b) obtaining a price quotation for assembly and pick up of the materials from the single material source; and
c) obtaining a price quotation for assembly and shipment of the materials from the single material source.

7. The method of claim 4 wherein the step of selecting the project comprises:
a) entering an identification code for a particular project; and
b) receiving the list of required materials for completion of the project.

8. The method of claim 7 wherein the step of obtaining the at least one price quotation comprises:
a) searching the second database for one or more sources of the materials specified in the list of required materials stored in the first database;
b) sending a request to the at least one material source for the price quotation for the one or more of the materials from the list of required materials; and
c) receiving a price quotation from the least one material source for the one or more of the materials from the list of required materials.

9. The method of claim 8 wherein the step of receiving the price quotation comprises receiving a price quotation for a single material specified in the list of required materials from the first database.

10. The method of claim 9 wherein the step of receiving the price quotation comprises receiving a price quotation for the single material and shipment of the single material specified in the list of required materials from the first database.

11. The method of claim 8 wherein the step of receiving the price quotation comprises receiving a price quotation for all of the materials specified in the list of required materials from the first database.

12. The method of claim 11 wherein the step of receiving the price quotation comprises receiving a price quotation for all of the materials on the list of required materials from the first database and assembling or packaging all of the materials into a single unit.

13. The method of claim 12 wherein the step of receiving the price quotation comprises receiving a price quotation for all of the materials on the list of required materials from the first database, for assembling or packaging of all of the materials into a single unit, and for shipment of all of the materials.

14. The method of claim 8 wherein the method of submitting payment comprises:
a) selecting the price quotation received from the at least one material source; and
b) enabling payment of an amount equal to the price quotation to the at least one material source through the system.

15. The method of claim 4 wherein the step of selecting at least one project comprises:
a) selecting a project area of interest;
b) browsing a list of available projects within that project area; and
c) identifying a particular project of interest within the project area.

16. The method of claim 15 wherein the step of selecting the project area of interest comprises selecting a project area from the group consisting of: home improvement projects, cooking projects, educational projects, and landscaping projects.

17. The method of claim 15 further comprising the step of updating the list of available projects in each project area prior to browsing the list of available projects.

18. The method of claim 15 wherein the step of identifying a particular project of interest comprises:
a) applying a unique identification code to each project; and
b) inputting the identification code corresponding to the particular project of interest into the system.

19. The method of claim 18 wherein the step of applying a unique identification code to each project comprises:
a) applying the unique identification code to each project in the first database; and
b) applying the unique identification code to each publication of each project outside of the first database.
